(19) United States
(12) Patent Application Publication
(10) Pub. No.: US 2017/0364873 A1
(43) Pub. Date: Dec. 21, 2017

(54) SYSTEMS AND METHODS FOR BUSINESS-TO-BUSINESS COMMERCE AUTOMATION

(71) Applicants: JPMongan Chase Bank, N.A., New York, NY (US); Microsoft Technology licensing, LLC, Redmond, WA (US)

(72) Inventors: Stephen P. Turk, San Mateo, CA (US); Michael V. Ehrenberg, Redmond, WA (US)

(21) Appl. No.: 15/533,065

(22) PCT Filed: Dec. 3, 2015
(86) PCT No.: PCT/US15/63668

§ 371 Date: Jun. 5, 2017

Related U.S. Application Data
(60) Provisional application No. 62/086,949, filed on Dec. 3, 2014.
(60) Provisional application No. 62/159,608, filed on May 11, 2015.

(51) Int. Cl. G06Q 20/10; G06Q 20/38; G06Q 10/06

(52) U.S. Cl. CPC G06Q 20/10; G06Q 20/385; G06Q 10/06313

(57) ABSTRACT

Systems and methods for business-to-business commerce automation are disclosed. In one embodiment, a method may include (1) a payment facilitator receiving, from a supplier, a request for a unique identifier for an invoice for a buyer; (2) at least one payment facilitator computer processor assigning the unique identifier to the invoice; (3) the payment facilitator providing the unique identifier to the supplier; (4) the payment facilitator receiving the unique identifier from the buyer; (5) the at least one payment facilitator computer processor retrieving the associated invoice for the unique identifier; (6) the payment facilitator receiving a payment status for the associated invoice from the buyer; (7) the payment facilitator assigning a unique remittance number to the associated invoice and payment status; and (8) the payment facilitator sending the unique remittance number to a buyer bank.

### RELATED APPLICATIONS

The present application claims priority to U.S. Provisional Patent Application Ser. No. 62/086,949, filed Dec. 3, 2014 and U.S. Provisional Patent Application Ser. No. 62/159,608, filed May 11, 2015. The disclosure of each of these documents is hereby incorporated by reference in its entirety.

### BACKGROUND

### 1. Field of the Invention

The present invention generally relates to systems and methods for business-to-business commerce automation.

### 2. Description of Related Art

The business-to-business, or “B2B,” payment process is complex and inefficient for all parties involved in a transaction, including sellers, buyers, banks and Enterprise Resource Planning (“ERP”) system providers (e.g., Microsoft, SAP, Oracle, Intuit). Paper checks are still used for approximately 40% of all B2B Payments; it is the preferred method by suppliers for reconciliation.

Current B2B systems have several “friction points.” For example, from the seller/supplier's perspective, three-way reconciliation (seller invoice, buyer remittance, and payment receipt) is even more complex when receiving multiple payment types (e.g., paper check, automated clearing house (“ACH”), wire, credit card, etc.) with different standards. From the buyer's perspective, it is difficult to manage seller/supplier inquiries regarding the reconciliation of invoices to payments. From the bank's perspective, a bank must maintain an infrastructure to support paper checks, including services to match invoices, remittances, and payments such as a lockbox. From the ERP system Software provider's perspective, there is a limited ability to use valuable data to help automate tasks, provide insights to corporate clients, etc.

### SUMMARY

Systems and methods for business-to-business commerce automation are disclosed. In one embodiment, a method for business-to-business commerce automation between a buyer and a seller using a payment facilitator may include (1) a payment facilitator receiving, from a supplier, a request for a unique identifier for an invoice for a buyer; (2) at least one payment facilitator computer processor assigning the unique identifier to the invoice; (3) the payment facilitator providing the unique identifier to the supplier; (4) the payment facilitator receiving the unique identifier from the buyer; (5) the at least one payment facilitator computer processor retrieving the associated invoice for the unique identifier; (6) the payment facilitator receiving a payment status for the associated invoice from the buyer; (7) the payment facilitator assigning a unique remittance number to the associated invoice and payment status; and (8) the payment facilitator sending the unique remittance number to a buyer bank.

In one embodiment, the payment facilitator may receive the request for a unique identifier for an invoice for a buyer from a supplier Enterprise Resource Planning system interface.

In one embodiment, the payment facilitator may receive the payment status for the associated invoice from a buyer Enterprise Resource Planning system.

In one embodiment, the unique remittance number may be associated with a plurality of invoices.

In one embodiment, the method may further include the payment facilitator receiving the remittance number and a certification request from the buyer bank.

According to another embodiment, a method for business-to-business commerce automation between a buyer and a seller using a payment facilitator may include (1) a supplier requesting, from a payment facilitator, a unique identifier for an invoice for a buyer; (2) the supplier receiving the unique identifier from the payment facilitator; (3) a supplier bank receiving a payment file from buyer bank, the payment file comprising a supplier identifier, a unique remittance number, and a payment; (4) the supplier bank retrieving supplier account information for the supplier identifier; and (5) the supplier bank depositing the payment to an account for the supplier based on the supplier account information.

In one embodiment, the request for a unique identifier for an invoice may be provided from a supplier Enterprise Resource Planning system.

In one embodiment, the payment file may further include a supplier routing number.

In one embodiment, the unique remittance number may be associated with a plurality of invoices.

In one embodiment, the supplier account information may be retrieved from a supplier directory.

In one embodiment, the supplier directory may include a plurality of supplier identifiers, each supplier identifier associated with supplier account information for a supplier.

In one embodiment, the supplier directory may be associated with a plurality of banks.

In one embodiment, the method may further include the supplier reconciling the payment with the payment facilitator.

In one embodiment, the supplier may reconcile the payment using a supplier Enterprise Resource Planning system.

In another embodiment, a system for business-to-business commerce automation between a buyer and a seller using a payment facilitator may include a supplier that supplies a good or service; a supplier bank, the supplier having an account with the supplier bank; a buyer that buys the good or service from the supplier; a buyer bank, the buyer having an account with the buyer bank; and a payment facilitator interfacing with the supplier, the supplier bank, the buyer, and the buyer bank. Using a supplier Enterprise Resource Planning system interface, the supplier may request a unique identifier for an invoice for a buyer from a payment facilitator; the payment facilitator may automatically assign the unique identifier to the invoice; the buyer may receive the unique identifier and the associated invoice; using a buyer ERP system, the buyer may assign a payment status to the associated invoice; the payment facilitator may receive the payment status from the buyer ERP system and assigns a unique remittance number to the associated invoice and its payment status; the payment facilitator may send the unique remittance number to the buyer bank; the buyer bank may provide payment instructions to the supplier bank; and the supplier bank may receive the payment and deposits the payment into a supplier account.

In one embodiment, the system may further include a supplier directory comprising a plurality of supplier identifiers, each supplier identifier associated with supplier account information for a supplier. The payment instructions may include a supplier identifier, a unique remittance number, and a payment; and the supplier bank may retrieve the supplier account from the supplier directory.

In one embodiment, the buyer bank may further validate the unique remittance number with the payment facilitator before providing payment instructions to the supplier bank.

In one embodiment, the payment facilitator may send the unique identifier to the supplier after it is automatically assigned.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for business-to-business commerce automation according to one embodiment;

FIG. 2 depicts a method for business-to-business commerce automation according to one embodiment;

FIG. 3 depicts a system for business-to-business commerce automation according to another embodiment;

FIG. 4 depicts a method for business-to-business commerce automation according to another embodiment;

FIG. 5 depicts a supplier directory dataflow according to one embodiment; and

FIG. 6 depicts a processing machine according to one embodiment.

### DETAILED DESCRIPTION OF PREFERRED EMBODIMENTS

Systems and methods for business-to-business commerce automation and receivables management are disclosed. Embodiments may be considered “interoperable” or “open” in that they may work with all payment types, software vendors/products, and clients. Embodiments may be global in that they may work across all major jurisdictions. Embodiments may provide quality assurance, in that a bank should not release or “certify” a payment that does not meet system-defined data standards. Embodiments may also enable sellers/suppliers to issue bills with unique identifiers.

Embodiments may provide easy adoption in that they may not require the buyer or the seller/supplier to change the manner in which they operate. They may improve communications between the buyer and the seller/supplier, and may keep the buyer and seller/supplier informed as to status of payment. Embodiments may optimize discounting decisions for the buyer and/or seller/supplier. Embodiments may also support global unique customer identification, such as a legal entity identifier.

The systems and methods may be scalable, and may be extendable to current and future payment networks. In one embodiment, the systems and methods may be extended to manage receivables, an example of which is disclosed in U.S. patent application Ser. No. 11/779,105, the disclosure of which is hereby incorporated by reference in its entirety.

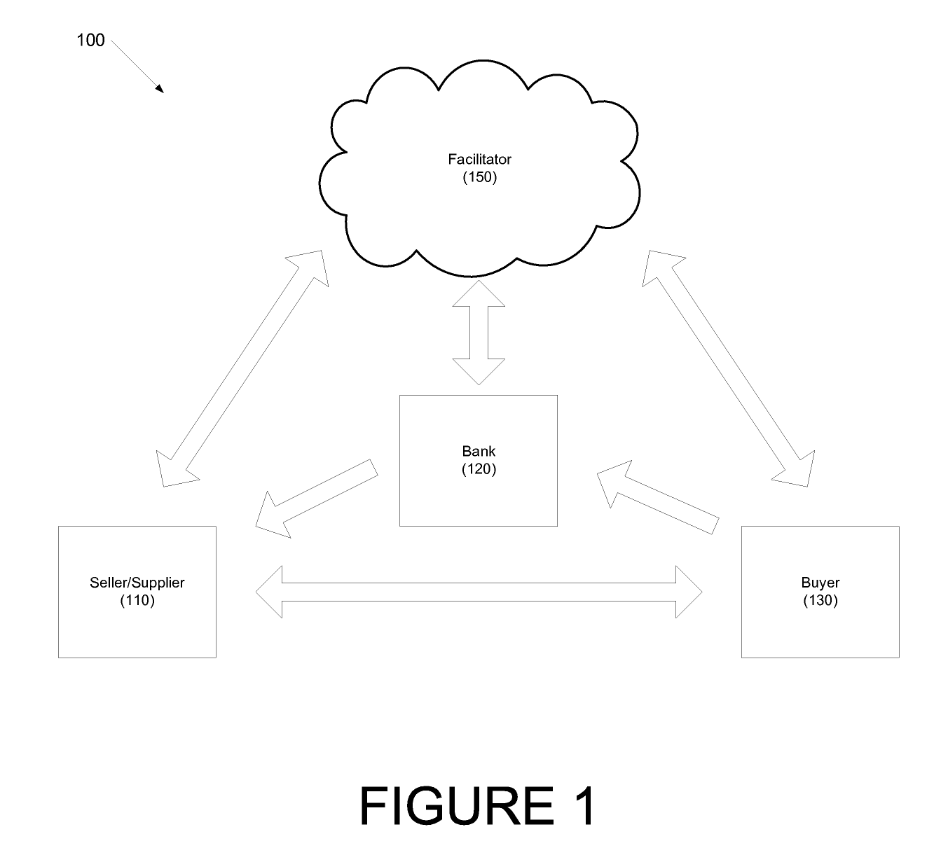

Referring FIG. 1, an embodiment of a system for business-to-business commerce automation is disclosed. System 100 may include seller/supplier 110, bank 120, buyer 130, and facilitator 150. Seller/supplier 110 may be any seller, supplier, or provider of any good or service. Buyer 130 may be any purchaser, consumer, or reseller of any good or service provided by seller/supplier 110. Bank 120 may be one or more financial institutions with which seller/supplier 110 and/or buyer 130 has an account. Facilitator 150 may facilitate the invoicing, remittance, and payment for the goods or services.

Although only one bank 120 is illustrated, it should be understood that seller/supplier 110 and buyer 130 may have accounts with different banks.

Seller/supplier 110, bank 120, buyer 130, and/or facilitator 150 may include, or be referred to interchangeably with, particularly configured computing devices for performing actions, such as those described herein, and may communicate using any suitable communication mechanism, including, for example, the Internet, virtual private networks, telephone, facsimile, etc.

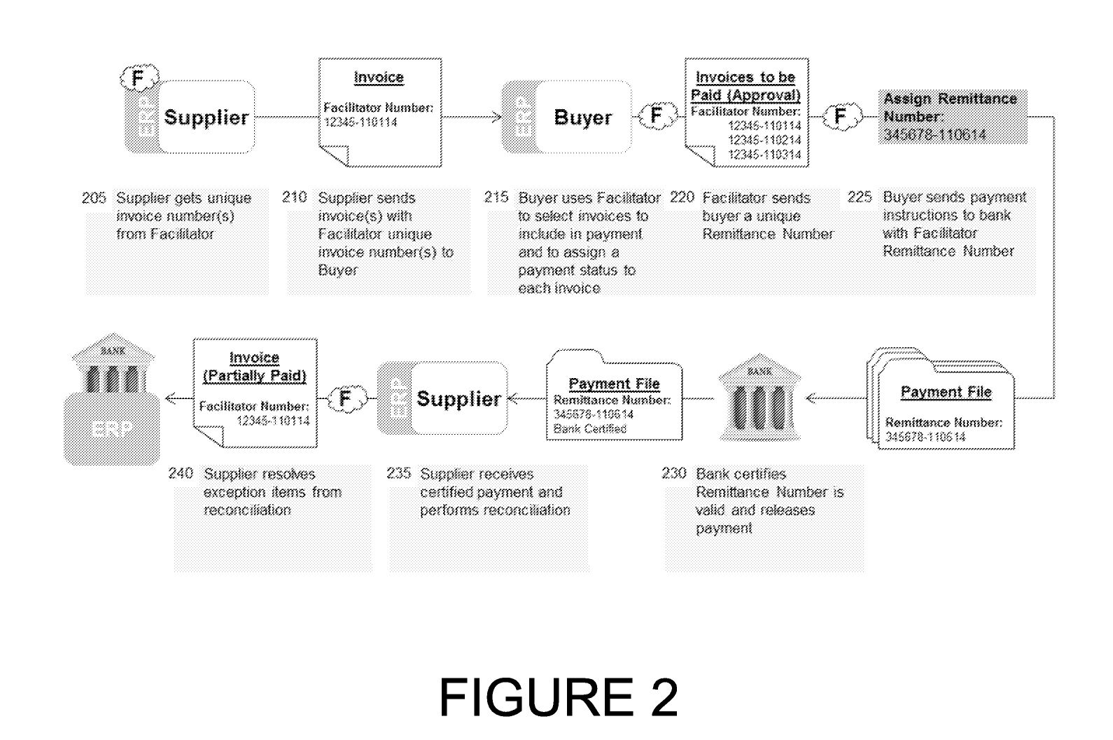

Referring to FIG. 2, a method for business-to-business commerce automation is disclosed according to one embodiment.

In step 205, a seller/supplier may receive one or more unique invoice numbers from the facilitator. In one embodiment, each facilitator invoice number may be a unique number that may include a unique supplier identifier and a timestamp. In one embodiment, certain digits/letters may be used to identify the seller/supplier. For example, the first five digits may be used to identify the seller/supplier, and the following digits may be used to identify the invoice.

In one embodiment, the facilitator invoice number may be assigned by the facilitator. For example, the seller/supplier may send an invoice to the facilitator, which may then assign the facilitator invoice number to the invoice. In another embodiment, the facilitator may provide the seller/supplier with a range of facilitator invoice numbers, and the seller/supplier may associate one of the facilitator invoice numbers with an invoice, and may report the association to the facilitator.

In another embodiment, the seller/supplier may be assigned one or more prefixes by its bank. In one embodiment, the prefix may map to an account at that seller/supplier bank where the funds should be deposited. In one embodiment, the association between the prefix and the bank may be shared with the payment network, while the association between the prefix and a specific seller/supplier account at the bank may be retained privately by the bank.

Any suitable manner of assigning or associating a facilitator invoice number to a seller invoice may be used as necessary and/or desired.

Because the invoice may include the prefix that enables the payment to be correctly routed by the network back to the seller/supplier s bank, it does not require the seller/supplier's contact information in the buyer's system to be current.

In one embodiment, the seller/supplier's ERP system may communicate with the facilitator to obtain a unique facilitator invoice number for each seller invoice.

In one embodiment, the facilitator invoice number may be assigned to one or more line items of an invoice. For example, if an invoice has multiple line items, a separate facilitator invoice number may be assigned to each line item.

In step 210, the seller/supplier may send one or more invoices to the buyer. In one embodiment, each invoice or invoice line item generated may include or be associated with the facilitator invoice number.

In step 215, the buyer may receive the invoice from the seller/supplier that includes the facilitator invoice number. The buyer may select one or more invoices, line items, etc. for payment and also provide the payment status using, for example, facilitator-defined choices. For example, these choices may include the buyer fully paying the invoice, the buyer taking a standard discount, the buyer partially paying the invoice, etc.

In one embodiment, the buyer may perform this selection using a program, an application, a website, etc. that may be hosted or provided by the facilitator. In one embodiment, the buyer may access the facilitator using its ERP system.

In step 220, the facilitator may create and send a remittance number to the buyer that is linked to the invoices that the buyer has selected for payment. For example, the remittance number may identify all invoices paid and each invoice's payment status (e.g., full payment, standard discount taken, partial payment, etc.). In one embodiment, the remittance number may be linked to and represent the linked invoices. The remittance number may be unique and may include a buyer identifier and a timestamp.

In step 225, the buyer may send payment instructions to its bank with the facilitator remittance number. In one embodiment the payment instructions may be sent as a payment file including payment instructions for more than one facilitator remittance number.

In step 230, the bank may receive the payment instruction, including the facilitator remittance number. In one embodiment, the bank may certify that the remittance number is valid (e.g., correct number and field) and may release the certified payment.

In one embodiment, the bank may provide an additional certification number or certification status.

In step 235, the seller/supplier may receive the payment file, including the remittance number, and may access the facilitator to determine which invoices, or invoice line items, have been paid and their individual payment status (e.g., fully paid, standard discount taken, partially paid, etc.). For example, the seller/supplier may use its ERP system to make this determination, may access the facilitator, may access information from the bank (e.g., it may purchase services from the seller/supplier bank that includes this additional information along with their standard deposit reporting (e.g. electronic lockbox), etc.), etc.

In step 240, the seller/supplier may focus on any exceptions (e.g., partially paid invoices or invoice line items) as fully paid and standard discount taken invoices are reconciled.

In one embodiment, the facilitator may be an entity that is paid for its services by subscription, invoice, and reconciliation fees.

In one embodiment, the facilitator may provide advanced subscription services in which it may provide centralized storage of supplier payment instructions and discount terms so that there is no need to for the buyer to store/key this information. It may also provide a “2-way” line item invoice/remittance standard format. It may also provide payment status messaging (e.g., buyer approval, payment status, etc.) and analytics. It may also serve international clients.

In another embodiment, the system and method may provide wholesale access to central supplier payment information and instructions.

In one embodiment, the system and method may provide discounting services (e.g., dynamic discounting, receivables purchasing, etc.). “Dynamic discounting” may describe payment terms between a buyer and supplier to accelerate payment in return for a discount. The discount may vary according to the date of early payment, so that the earlier the payment, the greater the discount. Dynamic discounting may be facilitated by storing discounts centrally with the facilitator and time stamping the activities between invoicing and when a payment clears.

Examples of dynamic discounting systems, methods and techniques that may be used are disclosed in U.S. Pat. Nos. 8,108,296; 8,478,637; and 8,554,673; and U.S. patent application Ser. Nos. 13/904,663; 13/794,018; and 13/893,769. The disclosures of each of these patents and patent applications is hereby incorporated by reference in its entirety.

According to another embodiment, a data directory system, such as a payee directory system or a supplier directory system, may be provided or otherwise utilized. The supplier directory may be provided, for example, to store and/or operate on sensitive supplier information, remittance account detail, account numbers, etc. Thus, the supplier directory may enable a buyer to make electronic payments without having information on the seller/supplier's bank account information.

The use of a supplier directory may eliminate or reduce the risk of unauthorized access to seller/supplier financial information. It may also accelerate check-to-ACH conversion and accelerate payments. By using a supplier directory, a seller/supplier may not need to provide its account information to a buyer. In addition, the buyer may not need to maintain account information for the seller/supplier. Further, because the bank has certain know your customer (“KYC”) requirements as well as confidentiality policies and related operating processes, the buyer making the payment may have confidence that the payment (1) does not violate anti-money laundering laws, rules, and/or policies and (2) is not fraudulent.

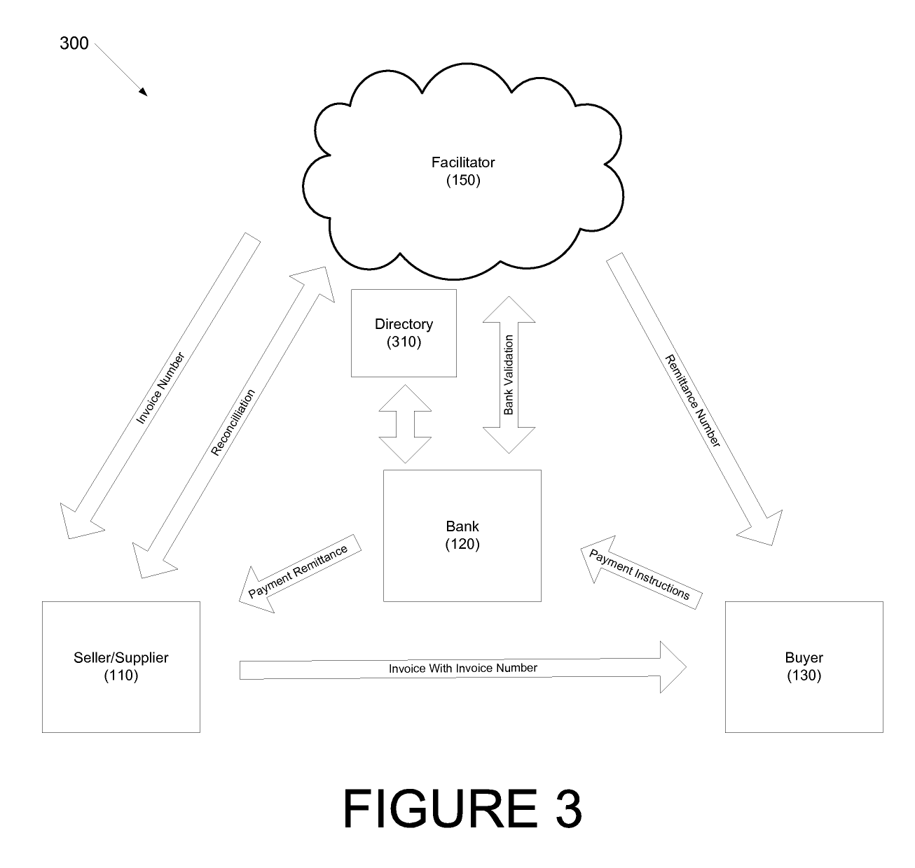

Referring to FIG. 3, a system for business-to-business commerce automation is disclosed according to another embodiment. Like system 100 depicted in FIG. 1, system 300 may include seller/supplier 110, bank 120, buyer 130, and facilitator 150. In addition, system 300 may include directory 310, which may include, or be referred to interchangeably with, one or more particularly configured computing devices for performing actions, such as those described herein. In one embodiment, bank 120 may interact with directory 310. In one embodiment, each bank 120 may have its own directory 310; in another embodiment, a single directory 310 may service more than one bank 120.

In one embodiment, directory 310 may be a supplier directory. Directory 310 may capture and utilize a seller/supplier's confidential or sensitive information (e.g., bank account details, etc.) so that a buyer may make an electronic payment without the seller/supplier's bank account details. In one embodiment, this may include the same unique supplier identifier as the one the facilitator provided. For example, this may include the unique supplier identifier, the supplier's associated bank account number, etc.

In one embodiment ,the supplier directory may assign a two-component prefix to the supplier. The first component may identify the seller/supplier's bank, and the second component may identify the seller/supplier's account within the seller/supplier's bank. Such a two-component prefix uniquely identifies a seller/supplier's bank account, and is essentially a tokenized form of the account number. The seller/supplier's bank account number itself is not publicly exposed and is only managed between the supplier directory and the seller/supplier. Thus, the seller/supplier's account number is not exposed for malicious use through other mechanisms.

In one embodiment, the identifier and/or other information may be encrypted. For example, information identifying the seller/supplier's bank and bank account may be tokenized. The identifying information can be validated by the seller/supplier's bank for any submitted transaction.

In one embodiment, as a buyer may also be a seller/supplier, directory 310 may maintain similar information for a buyer.

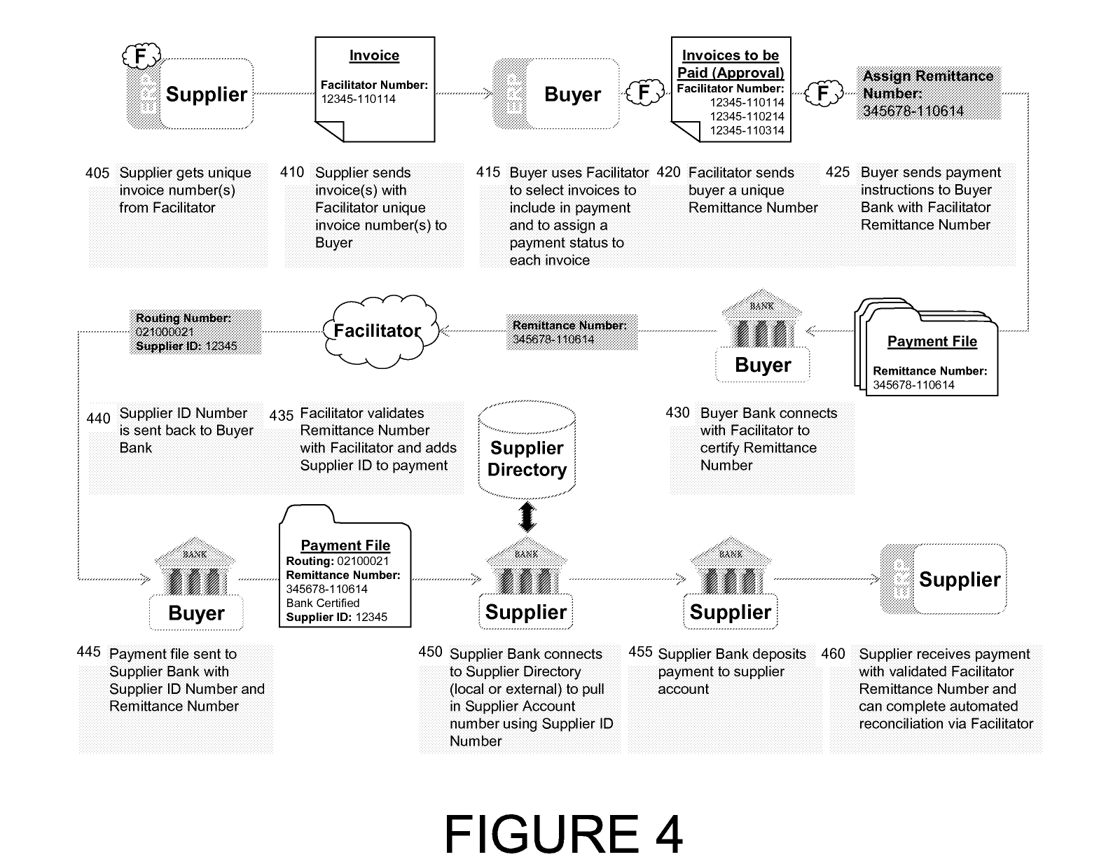

Referring to FIG. 4, a method for payment processing is disclosed. In step 405, a seller/supplier may receive a unique invoice number from the facilitator. In one embodiment, this may be similar to step 205, described above.

In step 410, the seller/supplier may send one or more invoices, or invoice line items, to the buyer. In one embodiment, each invoice or invoice line item may be associated with a facilitator invoice number. In one embodiment, this may be similar to step 210, described above.

In step 415, the buyer may receive the invoice from the seller/supplier that may include the facilitator invoice number, and may select one or more invoices or line items for payment, and may also provide the payment status using, for example, facilitator-defined choices. In one embodiment, this may be similar to step 215, described above.

In step 420, the facilitator may create and send a remittance number to the buyer that is linked to the invoices or line items that the buyer has selected for payment. In one embodiment, this may be similar to step 220, described above.

In step 425, the buyer may send payment instructions to its bank with the facilitator remittance number. In one embodiment, this may be similar to step 225, described above.

In step 430, the buyer's bank may validate the remittance number with the facilitator.

In one embodiment, in step 435, the facilitator may validate that the remittance number matches the one issued to that buyer and may add the supplier identifier to the payment. In one embodiment, the facilitator may also provide the supplier's bank routing number if not part of the supplier identifier.

In step 440, the facilitator may provide the buyer's bank with the supplier identifier for the buyer's bank to add payment instructions.

In step 445, the payment file including the supplier identifier and the remittance number may be provided to the seller/supplier's bank.

In step 450, the seller/supplier's bank may retrieve the supplier account number from the supplier directory using the supplier identifier. In one embodiment, the supplier directory may be internal to the supplier bank. In another embodiment, the supplier directory may be external to the supplier bank.

In step 455, using the supplier account number, the seller/supplier's bank deposits the payment to the seller/supplier's account.

In one embodiment, the payment may be held in escrow until deposited into the seller/supplier's account. In another embodiment, the payment may be held in a temporary account at the seller/supplier's bank until deposited. In another embodiment, the payment may be transferred, for example, by Electronic Funds Transfer (“EFT”), once the seller/supplier's account number is identified.

In step 460, the seller/supplier's receives payment with a validated facilitator remittance number and may complete reconciliation via the facilitator as discussed above.

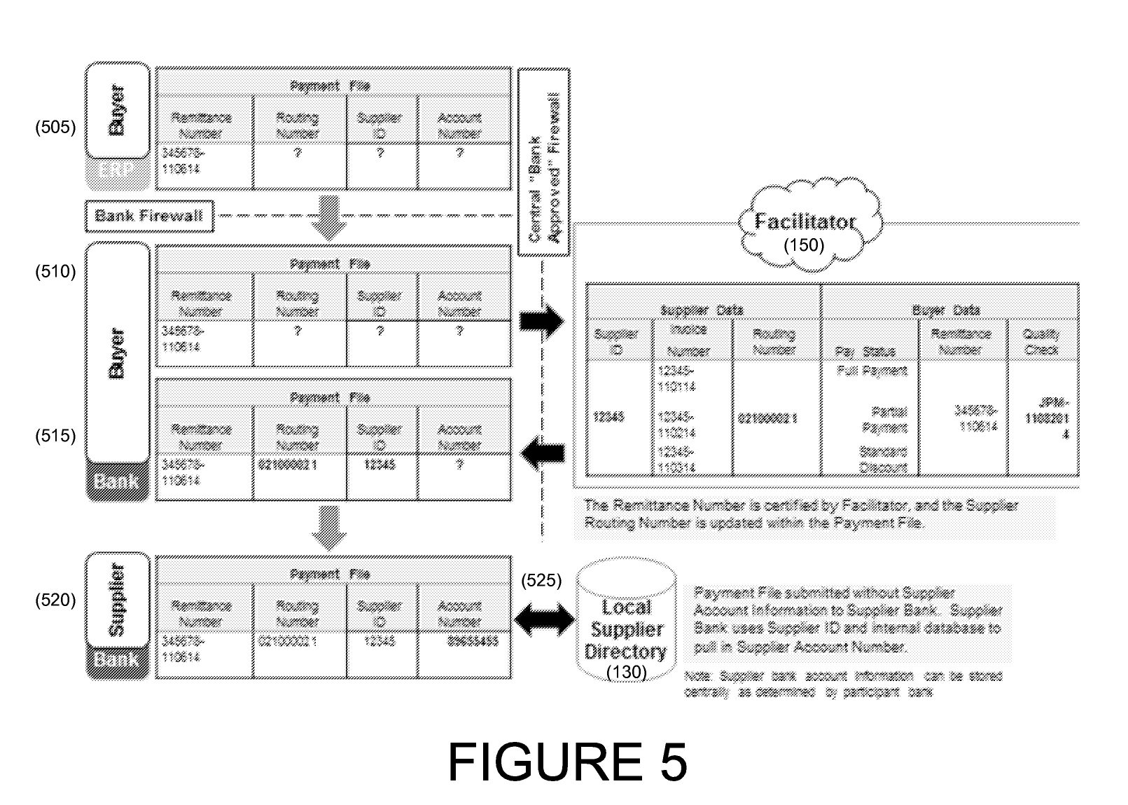

Referring to FIG. 5, a supplier directory dataflow is illustrated according to one embodiment.

In step 505, a payment file that is sent from the buyer to the buyer bank may include a remittance number. The routing number, supplier identifier, and the supplier account number may not be known and/or are not provided.

In step 510, the buyer bank communicates with the facilitator to retrieve supplier data using the remittance number. For example, the facilitator may provide the supplier identifier, invoice number(s) for the remittance number, and a routing number. As noted above, the payment file from the buyer may further identify the payment status associated with the invoice(s).

In step 515, the payment is updated with the seller/supplier's bank's routing number and the supplier identifier.

In step 520, the buyer bank provides the payment instructions to the seller/supplier's bank. In step 525, the seller/supplier's bank may then retrieve the seller/supplier's account number from the supplier directory using the supplier identifier. In one embodiment, the seller/supplier's bank may refer to any other internal databases to determine and/or verify the supplier account number as is necessary and/or desired.

It should be recognized that although several embodiments have been disclosed, these embodiments are not exclusive and aspects of one embodiment may be applicable to other embodiments.

Hereinafter, general aspects of implementation of the systems and methods of the invention will be described.

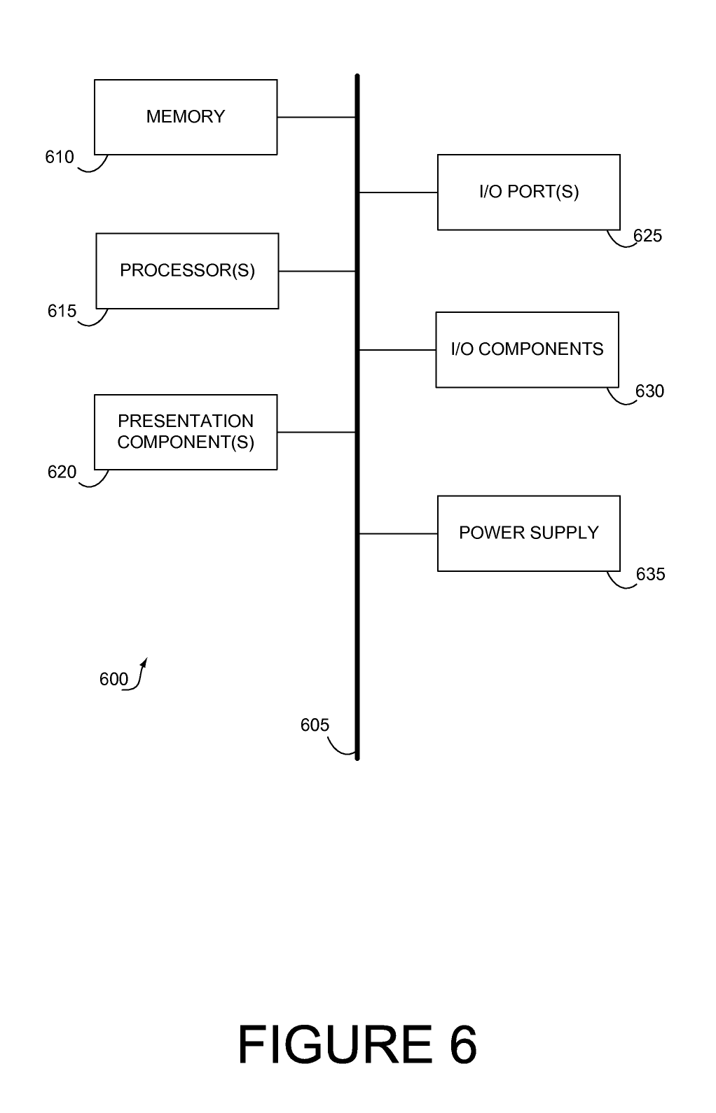

The system of the invention or portions of the system of the invention may be in the form of a “processing machine,” such as a general purpose computer, for example. Referring to FIG. 6, exemplary processing machine 600 is provided. As used herein, the term “processing machine” is to be understood to include at least one processor, such as processor 615, that uses at least one memory, such as memory 610. Processing machine 610 may further include at least one presentation component 620, which may include, for example, any suitable display. Input/Output (“I/O”) ports 625 and I/O components 630 may be provided for humans and other devices to interface with processing machine 600. Processing machine 600 may be powered via power supply 635, which may be any suitable power supply. One or more bus 635 may be provided, and one or more component of processing machine 600 may interface via bus 605.

The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 10 operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Windows Azure platform, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for business-to-business commerce automation between a buyer and a seller using a payment facilitator, comprising:
a payment facilitator receiving, from a supplier, a request for a unique identifier for an invoice for a buyer;
at least one payment facilitator computer processor assigning the unique identifier to the invoice;
the payment facilitator providing the unique identifier to the supplier;
the payment facilitator receiving the unique identifier from the buyer;
the at least one payment facilitator computer processor retrieving the associated invoice for the unique identifier;
the payment facilitator receiving a payment status for the associated invoice from the buyer;
the payment facilitator assigning a unique remittance number to the associated invoice and payment status; and
the payment facilitator sending the unique remittance number to the buyer bank.

2. The method of claim 1, wherein the payment facilitator receives the request for a unique identifier for an invoice for a buyer from a supplier Enterprise Resource Planning system interface.

3. The method of claim 1, wherein the payment facilitator receives the payment status for the associated invoice from a buyer Enterprise Resource Planning system.

4. The method of claim 1, wherein the unique remittance number is associated with a plurality of invoices.

5. The method of claim 1, further comprising:
the payment facilitator receiving the remittance number and a certification request from the buyer bank.

6. A method for business-to-business commerce automation between a buyer and a seller using a payment facilitator, comprising:
a supplier requesting, from a payment facilitator, a unique identifier for an invoice for a buyer;
the supplier receiving the unique identifier from the payment facilitator;
a supplier bank receiving a payment file from a buyer bank, the payment file comprising a supplier identifier, a unique remittance number, and a payment;
the supplier bank retrieving supplier account information for the supplier identifier; and
the supplier bank depositing the payment to an account for the supplier based on the supplier account information.

7. The method of claim 6, wherein the request for a unique identifier for an invoice is provided from a supplier Enterprise Resource Planning system.

8. The method of claim 6, wherein the payment file further comprises a supplier routing number.

9. The method of claim 6, wherein the unique remittance number is associated with a plurality of invoices.

10. The method of claim 6, wherein the supplier account information is retrieved from a supplier directory.

11. The method of claim 10, wherein the supplier directory comprises a plurality of supplier identifiers, each supplier identifier associated with supplier account information for a supplier.

12. The method of claim 10, wherein the supplier directory is associated with a plurality of banks.

13. The method of claim 6, further comprising:
the supplier reconciling the payment with the payment facilitator.

14. The method of claim 13, wherein the supplier reconciles the payment using a supplier Enterprise Resource Planning system.

15. A system for business-to-business commerce automation between a buyer and a seller using a payment facilitator, comprising:
a supplier that supplies a good or service;
a supplier bank, the supplier having an account with the supplier bank;
a buyer that buys the good or service from the supplier;
a buyer bank, the buyer having an account with the buyer bank; and
a payment facilitator interfacing with the supplier, the supplier bank, the buyer, and the buyer bank;
wherein:
using a supplier Enterprise Resource Planning (ERP) system interface, the supplier requests a unique identifier for an invoice for a buyer from a payment facilitator;
the payment facilitator automatically assigns the unique identifier to the invoice;
the buyer receives the unique identifier and the associated invoice;
using a buyer ERP system, the buyer assigns a payment status to the associated invoice;
the payment facilitator receives the payment status from the buyer ERP system and assigns a unique remittance number to the associated invoice and its payment status;
the payment facilitator sends the unique remittance number to the buyer bank;
the buyer bank provides payment instructions to the supplier bank; and
the supplier bank receives the payment and deposits the payment into a supplier account.

16. The system of claim 15, further comprising:
a supplier directory comprising a plurality of supplier identifiers, each supplier identifier associated with supplier account information for a supplier;
wherein the payment instructions comprise a supplier identifier, a unique remittance number, and a payment; and
the supplier bank retrieves the supplier account from the supplier directory.

17. The system of claim 15, wherein the buyer bank further validates the unique remittance number with the payment facilitator before providing payment instructions to the supplier bank.

18. The system of claim 15, wherein the payment facilitator sends the unique identifier to the supplier after it is automatically assigned.
